(19) United States
(12) Patent Application Publication
(10) Pub. No.: US 2013/0214074 A1
(43) Pub. Date: Aug. 22, 2013

(54) LIGHTER SHAPED GRINDER

(71) Applicant: THE VIOLINA SYNDICATE, LLC, (US)

(72) Inventors: Eitam Scharf, Los Angeles, CA (US); Kimberly Dian Grant, Los Angeles, CA (US)

(73) Assignee: THE VIOLINA SYNDICATE, LLC, LOS ANGELES, CA (US)

(21) Appl. No.: 13/844,371

(22) Filed: Mar. 15, 2013

Related U.S. Application Data
(63) Continuation-in-part of application No. 13/400,016, filed on Feb. 17, 2012.
Application No. 13/400,016 is a continuation-in-part of application No. 12/010,763, filed on Jan. 29, 2008, now Pat. No. 8,019,164.

(30) Foreign Application Priority Data
Dec. 20, 2012 (CH) 201220710433.2

(51) Int. Cl. B02C 19/20

(52) U.S. Cl. CPC B02C 19/20
USPC 241/95

(57) ABSTRACT

A grinder in the form of a lighter where the grinding is performed on the outer shell. The grinder has unique groove patterns on the shell that form the grinding area. This lighter shaped grinder can grind herbs as well as other materials

### CROSS-REFERENCES TO RELATED APPLICATIONS

This application is a continuation-in-part of U.S. application Ser. No. 13/400,016, filed Feb. 17, 2012, which is a continuation-in-part of U.S. application Ser. No. 13/010,763, filed Jan. 20, 2011, both of which are incorporated by reference in their entirety.

This application also incorporates by reference the concurrently filed and commonly owned U.S. application entitled “Herb Grinder” (VIOLI-90073) by the same inventors.

### BACKGROUND

This invention relates generally to a grinder, and more particularly has reference to a lighter-shaped grinder especially adapted for cigarettes and other smoking material.

There are two types of cigarettes. The first is an already finished cigarette, and the second needs to be manually assembled by the smoker using leaves and cigarette paper. To make the cigarette, the user needs to have a grinder or a pair of scissors to grind or cut the leaf into fine pieces, which is often inconvenient.

A need exists for a new type of grinder which can solve the issue of inconvenience. The present invention fulfills that need.

### SUMMARY OF THE INVENTION

Briefly, and in general terms, the present invention relates to a new type of grinder embodying a shell in the shape of a lighter body with special groove patterns forming a grinding area on the shell.

The grooves can be in the shape of rectangles, squares, circles, ovals, hearts, or other polygonal shapes. Aligned and/or staggered arrangements of grooves can be used. The grooves also can be in the shape of concentric rings, and distributed at specific radial intervals. They can have a curved shape or be in a straight line, and can be distributed in parallel at specified intervals.

The grinder shell is generally in the form of a hollow elongated tubular or cylindrical structure with a cross-sectional shape that may be circular, oval or square with rounded or sharp corners. The grinder shell material may be plastic, metal, or wood. The grinder may feature multiple grinding areas on the outer surface of the shell.

The grinder may be provided with a plurality of through holes distributed both in the grooves and/or on the surface of the shell. The bottom end of the grinder may be either open or closed.

A grinder made in accordance with the present invention has a lighter-shaped body or shell which features a plurality of grooves or notches on the shell forming grinding areas, making it easier and more convenient to grind. The sidewalls of the grooves can be used as a grinding edge which can grind leaves and other kinds of materials.

Safety is a concern since the grinder needs to be able to be carried anywhere and used anytime like a conventional lighter. A grinder made in accordance with the present invention is safer to use because it does not require cutting blades or any sharp edges or parts sticking out from the surface of the grinder that could cut a user's fingers during use or cause personal injury. The grinding area is formed by the special grooved shell which makes grinding safe and easy. The grinder is particularly suitable for grinding softer herbs, spices, fruits, nuts, and tobacco, etc.

These and other features and advantages of the invention will become more apparent from the following detailed description, taken in conjunction with the accompanying drawings, which illustrate, by way of example, the features of the invention.

### BRIEF DESCRIPTION OF THE DRAWINGS

FIG. 1 is a perspective view of a lighter-shaped grinder embodying novel features of the present invention;

FIG. 2 is a side elevational view of the grinder shown in FIG. 1;

FIG. 3 is a perspective view of another embodiment of the invention;

FIG. 4 is a front elevational view of the grinder shown in FIG. 3;

FIG. 5 is a front elevational view of yet another embodiment of the invention;

FIG. 6 is a front elevational view of still another embodiment of the invention;

FIG. 7 is a front elevational view of another embodiment of the invention;

FIG. 8 is a front elevational view of yet another embodiment of the invention;

FIG. 9 is a front elevational view of still another embodiment of the invention;

FIG. 10 is a perspective view of another embodiment of the invention.

### DETAILED DESCRIPTION OF THE PREFERRED EMBODIMENTS

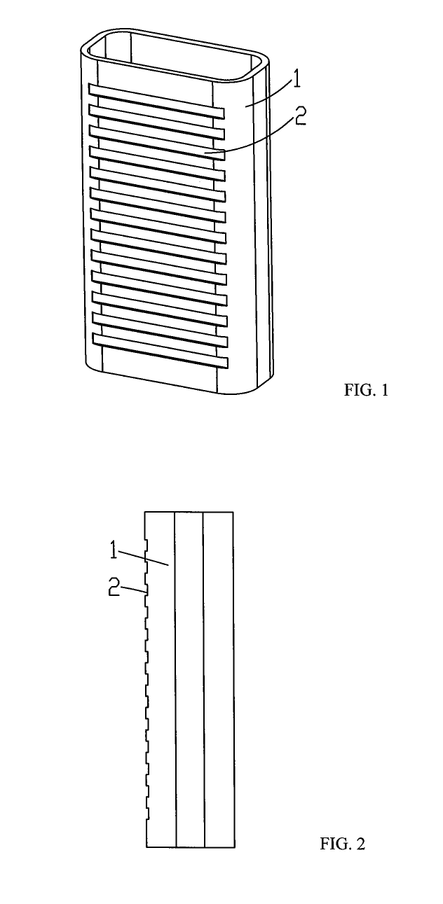

Referring now to the drawings, and in particular to FIGS. 1 and 2, the invention is embodied in grinder having a lighter-shaped body or shell with a plurality of notches or grooves 2 on the grinder shell 1. In accordance with the present invention, the grooves 2 and grinder shell 1 form a grinding area. In this embodiment, as best shown in FIG. 1, the cross-sectional shape of the shell is rectangular, with rounded corners. The grooves 2 in this particular embodiment, have an elongated rectangular shape and are arranged in straight lines, or strips, spaced apart and extending horizontally in parallel across a portion of a face of the shell. There are a plurality of grooves, and they are distributed in parallel at specified intervals across the exterior surface of the shell.

FIG. 2 shows the profile of the grinder of FIG. 1, illustrating the difference between the grooves and the surface of the grinder. The plurality of grooves 2 make it easy and convenient to grind. The sidewalls of the grooves 2 can be used as a grinding edge which can grind leaves, and other types of materials.

Safety is a concern since the grinder needs to be able to be carried anywhere and used anytime like a conventional lighter. Therefore, it is desirable to avoid any sharp edges or parts sticking out of the grinder surface. Otherwise, personal injury could occur. The benefit of using a grinder made in accordance with the present invention is that it is safer to use because it does not need any cutting blades on the surface that could cut a user's fingers during use. The grinding area is formed by the grinder shell 1 and the grooves 2, which makes the grinding safe and easy. The grinder is particularly suitable for use in grinding softer herbs, spices, fruits, nuts, and tobacco, etc.

While the grinder shell shown in FIG. 1 has a generally rectangular cross-sectional shape, it will be appreciated that the cross-sectional shape of the shell 1 can be circular, oval or any other shape.

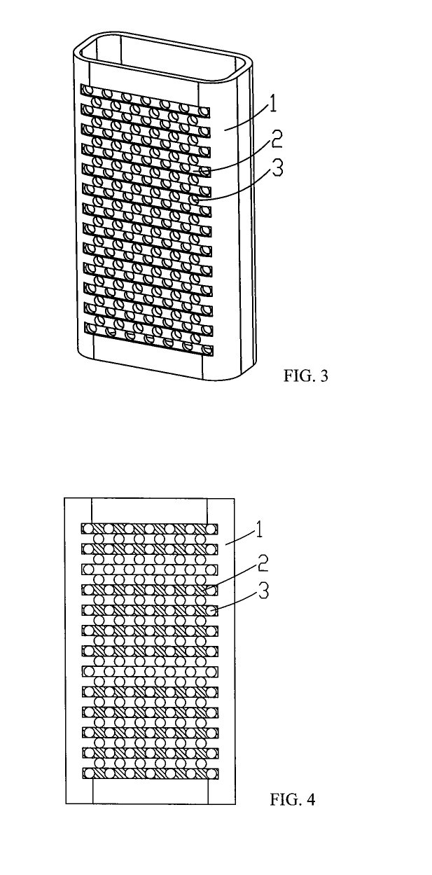

FIGS. 3 and 4 show an alternative embodiment of the invention. Compared to the first embodiment, the difference in this embodiment is that in addition to the grooves 2, there are a plurality of through holes 3 on grinder shell 1. These through holes 3 are distributed in the grooves or recessed areas, and on the surface of grinder shell 1 itself in the spaces between the grooves. These holes 3 perform both a grinding and cutting function. The holes add additional cutting edges to the grinder which makes it more efficient than the previous embodiment. The holes 3 can vary in size, location, concentration and spacing. In order to better illustrate the difference between the grooves and the adjacent surface of the sheet, the grooves have been illustrated with a hatching pattern in FIG. 4 (and in subsequent Figs.) to distinguish between the grooves and the adjacent spaces on the shell.

The bottom end of the grinder shell 1 can be either open or closed. When the bottom is open, the holes 3 have the added feature of expelling waste bits of ground material from the grinder preventing waste accumulation in the grooves 2 which could adversely affect the grinding. When the bottom of the shell is closed, the groove bits can be collected in the shell and then emptied out at a desired location.

FIG. 5 shows an alternative embodiment in which each of the grooves 2a has a square shape, and the grooves are arranged with alternating spaces in a checkerboard pattern. This checkerboard pattern forms a grinding area. Compared with the first embodiment, the grinding resistance is less, and results in a smoother and more delicate grind.

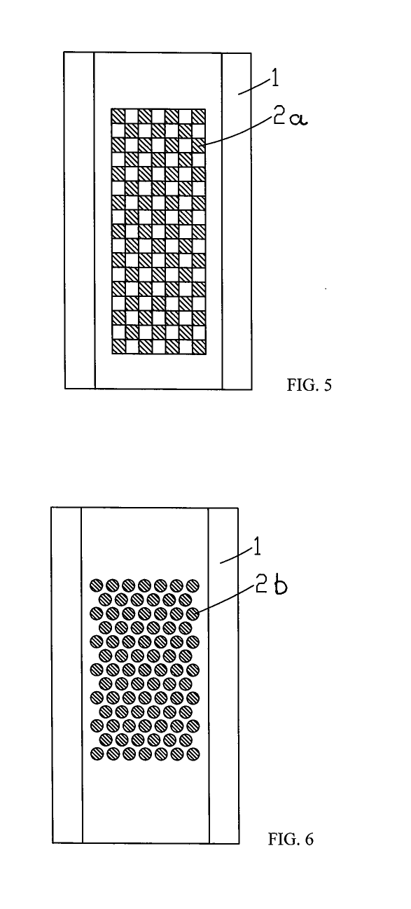

FIG. 6 shows another embodiment. In this embodiment, the shape of the grooved areas 2b is circular, and there are spaces between the circular grooves 2b. The grooved areas and grinder shell 1 form the grinding area.

In each of the above embodiments, the shape of grooved areas can be different from those illustrated, and can be triangles, rectangles, stars, polygons, ovals, hearts, gems or other irregular shapes, and combinations thereof. The shape and size of the grooved areas 2 also can be different, and can also be aligned unevenly.

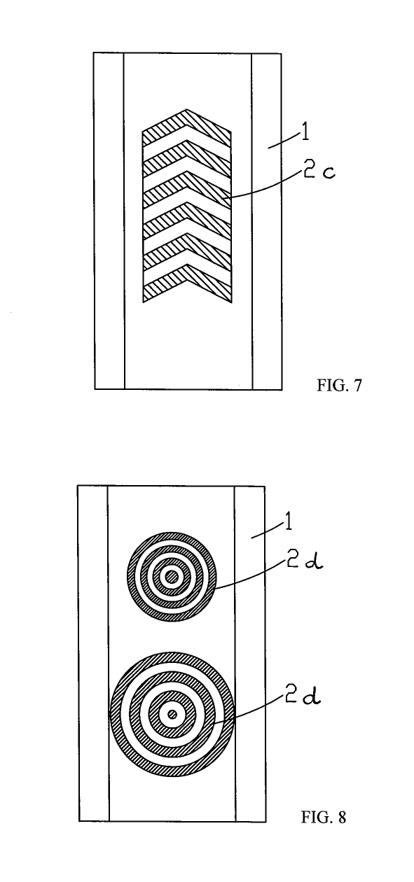

FIG. 7 shows another embodiment in which the grooved areas 2c form an angled, inverted V, or arrowhead, shape distributed in parallel at spaced interval on the shell 1 forming a grinding area. Because the grooves are bent at an angle, the sidewall segments provide an inward pushing effect on the material being ground, resulting in easier crushing and grinding of the material.

FIG. 8 shows another embodiment in which the grooved sections form a 2d series of concentric rings arranged at specified radial intervals on the shell 1 forming the grinding area. Because the grooves 2d are not straight lines in the grinding area, but are arcuate in shape, this also has the effect of pushing material inward when grinding, making it easier to crush and grind the material, and more efficient to use.

In the embodiment shown in FIG. 8, there are two separate grinding areas on the body or shell, and these two grinding areas are of two different sizes. These two areas can be used for different functions, as one can be used as a rough grinding area while the other can be used as a fine grinding area. This provides different selections of grinding areas within the same grinder.

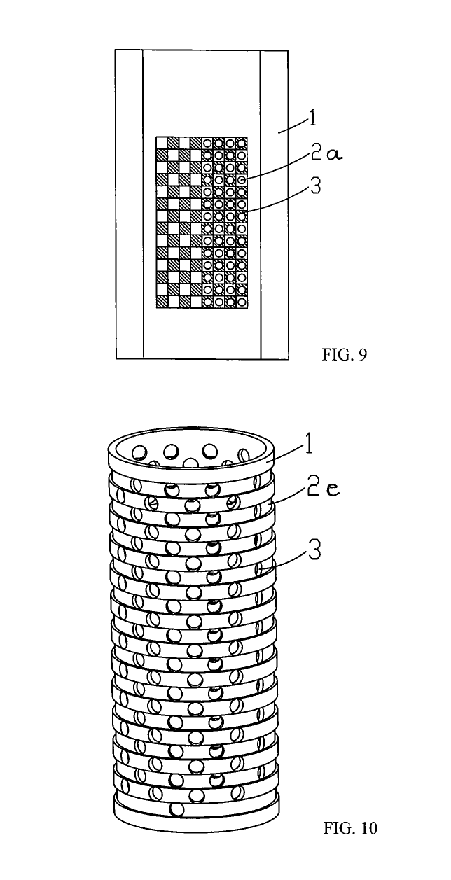

FIG. 9 shows another embodiment which uses two different grinding options within the same grinding area. The grinding area is similar to the one in FIG. 5, but includes through holes in both the grooves 2a and on the shell 1 in half of the grinding area, divided lengthwise. The portion of the grinding area without the through holes serves as a normal grinding area, while the portion with the through holes serve as a more high-efficient grinding zone.

FIG. 10 shows an alternative embodiment in which the shell is in the shape of a cylinder with a circular cross section, and the grooves 2e are provided by recessed sections of the shell having a smaller diameter in cross section. It also includes a plurality of through holes on both the surface of the shell and within the recessed sections.

In all of the embodiments described above, the notches or grooves are generally but not necessarily rectangular in cross section with sidewalls that are preferably but not necessarily perpendicular to the surface of the sheet. The angle between the sidewall and the surface of the shell can be either acute or obtuse. When the angle is acute, the grinding edge protrudes more. The cutting effect is enhanced, and the grinding effect is reduced. When the angle is obtuse, the cutting edge is blunt. The grinding effect is enhanced, while the cutting effect is reduced.

In all of the foregoing embodiments, the grinder shell can be made out of plastic, metal, wood or glass, and combinations thereof. The thickness of the shell is preferably between about 0.15 mm and 5 mm. The depth of the notches or grooves is preferably between about 0.005-2 mm. When the depth of the notch or groove is relatively small, it can grind to a more fine texture.

In all of the foregoing embodiments, there are many ways of forming the notches or grooves. For example, the notches or grooves can be formed using a CNC machine, mold stamping, laser cutting, or water jetting to process the shells. Another option is to use mask chemical corrosion which when processing, causes the bottom of the notches or grooves to be corroded and rough, which can enhance the grinding efficiency. The surface of the shell can be either smooth or rough, as desired.

The grooves and holes can be formed on a flat sheet of material, which is then rolled to form a tube. Alternatively, the grooves and holes can be formed directly on a finished tube or cylinder. The holes can be formed by stamping or punching or by any other suitable means.

It will be appreciated that each of the grinder shells described above can be used as a case or sleeve for holding a conventional lighter, or it can be integrated as part of the lighter body.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

We claim:

1. A lighter shaped grinder comprising a shell with a pattern of grooves on the shell forming a grinding area.

2. The grinder of claim 1, wherein the cross-sectional shape of the grinder is selected from the group consisting of circular, oval and square.

3. The grinder of claim 1, wherein the groove patterns have a shape selected from the group consisting of rectangles, squares, circles, ovals, hearts, and polygons with aligned or staggered arrangements between the grooves.

4. The grinder of claim 1, comprising a plurality of grooves in the shape of concentric rings that are distributed at specific intervals.

5. The grinder of claim 1, wherein the grooves have a curved shape, and are distributed in parallel intervals.

6. The grinder of claim 1, wherein the grooves have the shape of a straight line, and are distributed in parallel at specified intervals.

7. The grinder of claim 1, wherein the shell is made from plastic, metal or wood.

8. The grinder of claim 1, wherein the grinder has multiple grinding areas.

9. The grinder of claim 1, further comprising a plurality of through holes distributed in the grooves and/or on the surface of the shell.

10. The grinder of claim 1, wherein the bottom of the shell is open or closed.
